(19) United States
(12) Patent Application Publication
(10) Pub. No.: US 2013/0257739 A1
(43) Pub. Date: Oct. 3, 2013

(54) KEYPAD PERIPHERAL DEVICE

(71) Applicants: Jun Hyuk Chung, Los Angeles, CA (US); William Shin, Los Angeles, CA (US)

(72) Inventors: Jun Hyuk Chung, Los Angeles, CA (US); William Shin, Los Angeles, CA (US)

(21) Appl. No.: 13/438,832

(22) Filed: Apr. 3, 2012

(51) Int. Cl. G06F 3/02

(52) U.S. Cl. CPC G06F 3/0202
USPC 345/169

(57) ABSTRACT

A keypad peripheral device of the present disclosure includes a housing on top of which is located a keypad having a numeric keypad, function keys, Tab key, and right click key. The function keys may be F2 or F4 or both F2 and F4. Alternatively, F8 function key and/or directional keys may additionally be included. The present keypad peripheral device may further include the following keys: home, end, page up, and page down keys, and alternatively further comprise a back space or delete key or alt and control keys. Alternatively, at least one key of the keypad has a height that is less than at least another key of the keypad and this may be to avoid inadvertent contact with a finger or base of an operating hand. Further, an on/off switch may be provided on a bottom surface of the housing of the present computer peripheral device.

### FIELD OF THE INVENTION

The present disclosure generally relates to a keypad peripheral device and embodiments thereof useful for providing input signals to a computer.

### BACKGROUND OF THE INVENTION

A computer keyboard uses buttons or keys that act as mechanical levers or electronic switches and is in a typewriter style having a QWERTY key layout. It has become the main input device for computers after the decline of punch cards and paper tape. Even since the development of alternative input devices, such as the mouse, touch-screen, pen devices, character recognition and voice recognition, the keyboard currently remains the most commonly used and most versatile device used for direct human input into computers.

To enter numbers on such a traditional QWERTY computer keyboard, the top row which contains the ten digits is accessed. The left hand is used to enter the numbers 1, 2, 3, 4, and 5, and the right hand is used to enter the numbers 6, 7, 8, 9 and 0. When making inputs for mathematical calculations the shift key has to be pressed to access, among others, the “*”, “+”, “(”, and “)” keys. Therefore, one hand cannot be used to easily and quickly make number entries and calculator inputs on a simple QWERTY keyboard.

In view of the foregoing, full sized computer keyboards also containing a number keypad positioned adjacent and to the right of a QWERTY keyboard have come into use. A number keypad, or numpad or tenkey for short, contains the ten digits 0, 1, 2, 3, 4, 5, 6, 7, 8, and 9, and also the “+”, “*”, “−”, and “enter” keys. With the number keypad, a user can make faster number inputs because only one hand is necessary to make all of the digit entries. The shift key does not have to be pressed to access the “+” and “*” keys. For number intensive computer applications such as the spreadsheet, the number keypad thus is primarily used to make number entries instead of the top row on a traditional QWERTY keyboard.

In addition to a user being able to type in numbers and also press the “+”, “*”, “−”, and “Enter” with only one hand, a number keypad encourages work efficiency by allowing the user to maximize the time spent with his eyes on the computer screen. Because the top row of the QWERTY keyboard, which has the keys for entering numbers, is far from the starting position with the index fingers of the left and right on the F and J keys respectively, a user can easily lose maintenance of the eyes on the computer screen while using a traditional QWERTY keyboard without a number keypad. He often has to look down on the keyboard to find the top row to press the correct keys for number entry. With a number keypad however, all the digits are within easy reach with the middle finger of an operating hand on the “5” key which may be considered the starting position.

However, even on a traditional computer keyboard that includes a number keypad on the right part of the keyboard, a user still has to move his eyes from the computer screen to access certain other keys. Examples of other keys that are often used in many software applications, including financial software application or spreadsheet application such as MICROSOFT® EXCEL®, include at least one function key, Tab key, directional keys and the right click button. On a traditional desktop keyboard such as the 104 key or 109 key desktop keyboard, accessing the function keys and directional keys requires movement of the user's eyes from the computer screen and lifting of the operating hand from the starting position with the middle finger on the “5” key of the number keypad.

Moreover, laptop or notebook computers are designed with portability in mind and thus are made to be lighter and smaller than desktop computers. The inside top surface of laptop computers where the keyboard is located generally do not have enough space to include a separate number keypad. Currently, 13 inch (diagonal screen distance) laptop computers do not have a number keypad included. Some 15 inch and 17 inch laptop computers may include number keypads next to the QWERTY keyboard layout but because of space restrictions these included number keypads often have smaller keys compared to a desktop 101 or 104 keyboard and are not comfortable to use.

To address the problem of laptop computers not having a number keypad, separate number keypads which are portable and may be plugged in or wirelessly connected to a laptop computer have come into existence. These separate number keypads however mostly do not include any keys beyond the ten digits and the +, −, *, / and Enter keys. To access additional keys such as the function keys, Tab key, keyboard right click button, or the directional keys, the main laptop keyboard has to be accessed. In doing so, it is necessary for a user to take his eyes off the computer screen. This results in decreased work efficiency.

Therefore, in view of the foregoing, there exists a need in the art for a keypad peripheral device which is portable, and contains additional keys that are often accessed in various software applications such as spreadsheets. This device would be very useful if at the same time, it permits easy access of the additional keys while maintaining the middle finger of an operating hand or not straying far from digit “5” which can be considered the ready or starting position for fast number entry. Such a device would encourage maintenance of the user's eyes on the computer screen resulting in increased work efficiency.

### SUMMARY OF THE INVENTION

In an embodiment, a keypad peripheral device of the present disclosure includes a housing on top of which is located a keypad having a numeric keypad, function keys, Tab key, and right click key. In additional embodiments, the function keys may be F2 or F4, or both F2 and F4. Alternatively, F8 function key may additionally be included. In a further embodiment, the F2 or F4, or F2 and F4 keys may be located on a top row of the keypad. A tab key, in another embodiment, may be operable by the pinkie finger of an operating hand and further alternatively be located adjacent to the Enter key of the numeric keypad.

The present keypad peripheral device may also include directional keys. In another embodiment, the directional keys are in the shape of a sideways T and operable by the index finger 306 of an operating hand.

The present keypad peripheral device may further comprise the following keys: home, end, page up, and page down keys, and alternatively further comprise a back space or delete key or alt and control keys.

In some embodiments of the present computer peripheral device, at least one key of the keypad has a height that is less than at least another key of the keypad and this may be to avoid inadvertent contact with a finger or base of an operating hand. Further, an on/off switch may be included on a bottom surface of the housing of the present computer peripheral device.

### BRIEF DESCRIPTION OF THE DRAWINGS

FIG. 1 depicts a top view of a keypad peripheral device in accordance with an embodiment of the present disclosure.

FIG. 2 depicts a bottom view of a keypad peripheral device in accordance with an embodiment of the present disclosure.

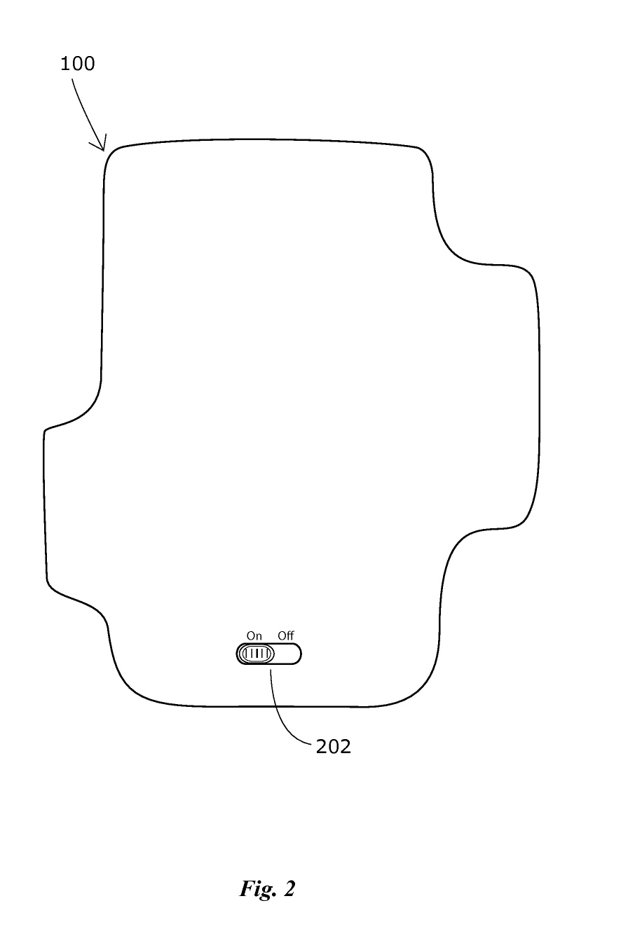

FIG. 3 depicts a top view of a keypad peripheral device which includes a wire connection in accordance with an embodiment of the present disclosure.

FIG. 4 depicts a perspective view of a keypad peripheral device in accordance with an embodiment of the present disclosure.

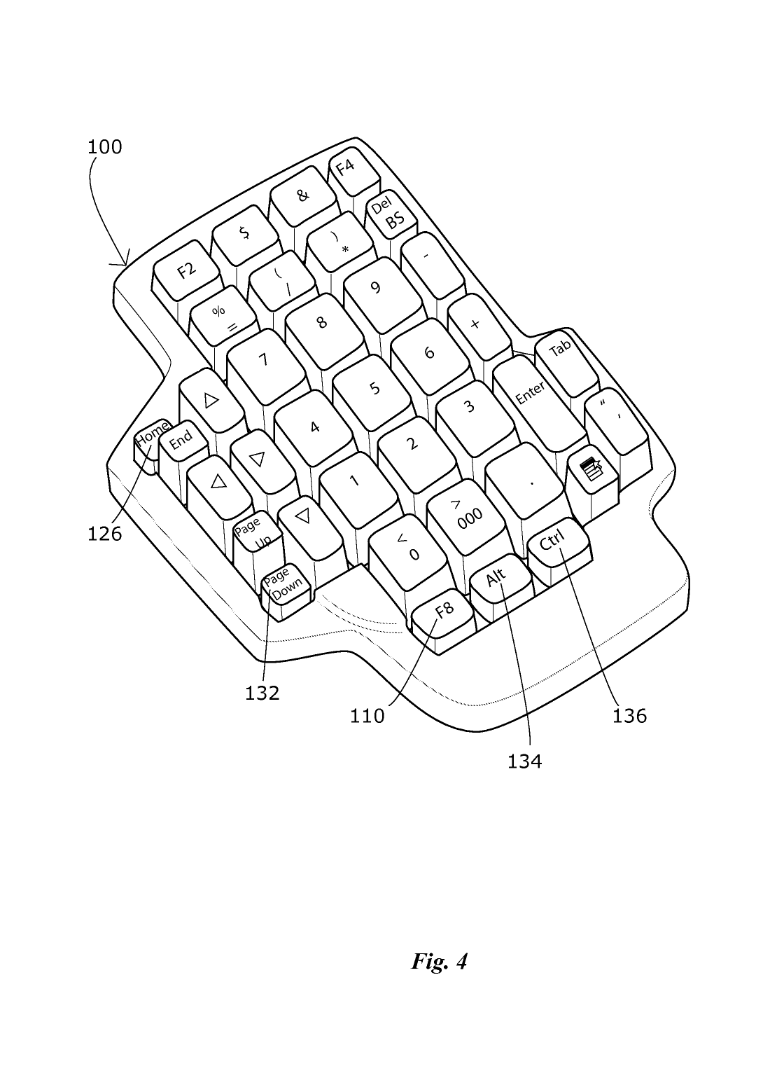

FIG. 5 depicts a perspective view of a keypad peripheral device which includes a wired connection and illustrates an operating hand in accordance with an embodiment of the present disclosure.

### DETAILED DESCRIPTION OF THE INVENTION

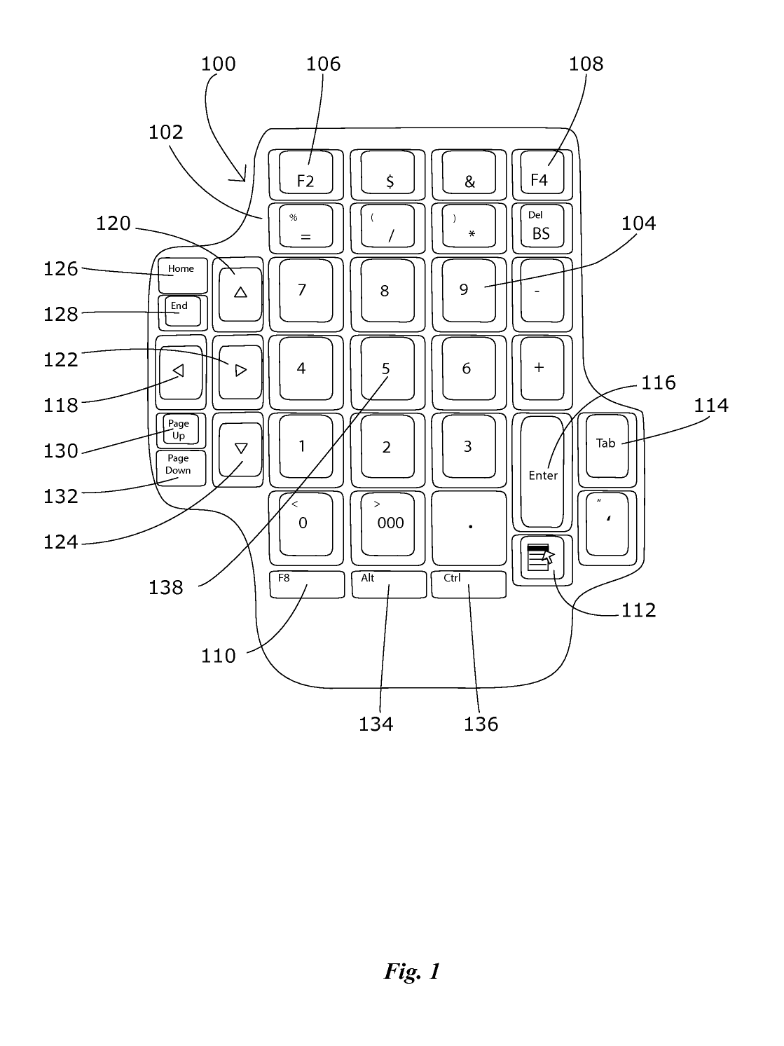

A keypad peripheral device 100 (FIG. 1) in accordance with the present disclosure has a housing 102 which forms a top surface on which is located a keypad having a numeric keypad 104, function keys (106, 108, 110), Tab key 114 and right click key 112.

A housing 102 forms a casing around and provides structure for the various embodiments of a keypad peripheral device 100, in accordance with the scope and content of the present disclosure. The housing may be made of, but not limited to, material such as plastic which typically serves as the material for a housing of existing computer keyboards.

A keypad peripheral device as disclosed herein includes a numeric keypad 104 that is located on a top surface or top part of the housing of the present keypad peripheral device. Top surface as used herein is the part which may be seen from a view from above when the keypad peripheral device is resting on a surface, with a bottom surface directly facing the working surface such as that of a desk or a table. The aforementioned housing may surround the keys of the keypad as the keys may be located through one or more openings on a top side of the structural housing.

A keypad within the scope and content of the present disclosure is a set of keys laid out to be accessible by fingers of an operating hand for computer entry. A keypad as used herein is not necessarily equivalent to a number keypad. Thus, the keypad as used herein includes a numeric keypad but may also include additional keys in various disclosed embodiments.

Numeric keypad or number keypad or numpad or tenkey are used as equivalents herein. A numeric keypad includes digits 0 to 9, addition (+), subtraction (−), multiplication (*) and division (/) symbols, a decimal point (.) and and Enter keys. As one of ordinary skill in the art understands, numeric keypads are useful for entering long sequences of numbers quickly, for example in spreadsheets, financial/accounting programs, and calculators. Input in this style is similar to that of a calculator or adding machine.

The numeric keypad, as described herein, may also include a “000” key in addition to the digit 0. Inclusion of the “000” key assists in faster number entry when multiple digit 0 entries with greater than three zeroes are necessary.

A keypad of the present keypad peripheral device further includes at least one function key. In additional embodiments, the included function keys are F2 106 or F4 108, or F2 and F4, or alternatively F2, F4 and F8 110 buttons.

Pressing F2 in the spreadsheet program MICROSOFT® EXCEL® permits a user to edit the cell that is currently active. This will also put the cursor at the end of whatever is currently in the cell, making this a good way to quickly add inputs to the current contents. Thus, F2 is often used in financial applications so that the contents of an existing cell are not totally deleted before editing. Also, in MICROSOFT® EXCEL®, the F4 button shortcut is used when a user wants to repeat the last action that he has just taken by selecting the range of cells where the action is desired to be repeated. For example, if one has just deleted a row and he wants to delete another row, he can simply select the range where he wants to delete the next row and press F4. If the user has just added cell borders to a range and he wants to format another range the same way, F4 will repeat the previous action for him. This is often most useful when the user want to repeat an action over and over. Pressing the F8 shortcut button allows a user in MICROSOFT® EXCEL® to enter an extend mode which allows the arrow keys to extend the selection. The F2, F4, and F8 keys are very useful and often used keys in MICROSOFT® EXCEL® and inclusion of the keys on the present keypad peripheral device helps increase work efficiency.

The keypad of the presently disclosed keypad peripheral device includes a Tab key. Inclusion of a Tab key increases work efficiency especially when using a spreadsheet computer program such as MICROSOFT® EXCEL®. When working in EXCEL®, a user often uses the Tab key. This is because after entering data or information into a cell, pressing the Tab key completes entry into a selected cell. When a Tab key is pressed the cursor moves to the adjacent cell located to the right of the previous cell. Pressing the Enter key also completes entry into a cell. However, pressing the Enter key moves the cursor to the cell directly below the previous cell. When working in EXCEL®, it is often desired to move to the cell to the right of and not below the previous cell. In an embodiment, the Tab key is located adjacent to the Enter key 116 of the number keypad of the presently disclosed keypad peripheral device. In the right handed configuration, the Tab key would be located to the right of the Enter key and in the left handed configuration, the Tab key would be located to the left of the Enter key. In this embodiment, the Tab button is easily reached by the pinkie or the 5^{th} finger 312 of the operating hand thus allowing the middle finger 308 to maintain a ready or starting position on digit “5” 138 or be only slightly removed from this position. In this ready position, the index finger and ring finger of the operating hand may naturally be located on digit “4” and digit “6” respectively.

In another embodiment, the present keypad peripheral device includes a right click key 112. The right click button is the same button that would typically be located in between the Alt and Ctrl buttons on the right side of a traditional 104 key computer keyboard. Inclusion of a right click button on the present keypad peripheral device results in increased work efficiency because an operator does not have to move his hand away from the number keypad to an external mouse right click button or right click button found below a laptop computer touchpad. While moving the hand to find a right click button on an external computer mouse or on a laptop, the operators eyes have to come off the computer screen.

In another embodiment, the right click key 112 is located directly below the Enter key 116 of the numeric keypad of the present keypad peripheral device. This allows easy access of the right click key with the pinkie finger 312 of an operating hand while maintaining the middle finger on digit “5.”

Alternatively, a set of keys that may be included in the present keypad computer peripheral device is the directional keys. Directional keys as used herein include the left 118, right 122, up 120, and down 124 arrow keys. In an embodiment, the directional keys are in the shape of a sideways T. By “sideways T” it is meant that up arrow, right arrow and down arrow are lined up as over a vertical line and the left arrow is located to the left of the right arrow. Sideways T configured directional keys allow easy access to them by the simple movement of the index finger 306 from digit 4. In an embodiment, simple movement of the index finger is all that is required to access the directional keys. This permits the other fingers to remain or not stray far from the aforementioned ready or starting position. Thus, even the placement of the directional keys encourages keeping the eyes on the computer screen and further results in greater work efficiency.

When using existing numeric keypad computer mice which do not have any directional keys, a user must move the operating hand away from the mouse in order to find the necessary keys on a separate keyboard. The operator's eyes will move away from the computer screen to find the separate directional keys reducing work efficiency. Moreover, the “sideways T” configuration and accessibility by the index finger of the directional keys in alternative embodiments, encourages efficiency because the directional keys are on the keypad peripheral device and also because they are accessible without losing the home position on the number keypad.

It is also within the scope and content of the present disclosure to include various embodiments of the instant keypad peripheral device to be used when the operating hand is the left hand as well as when the operating hand is the right hand. Left-handed keypad peripheral device of the present disclosure would essentially be a mirror image of the respective right-handed keypad peripheral device. Thus, in the left-handed keypad peripheral device, the directional keys would have the up arrow, left arrow and down arrow lined up as over a vertical line with the right arrow being located to the right of the left arrow. This would be the “sideways T” configuration for a left-hand keypad peripheral device of the present disclosure.

In alternative embodiments, the presently disclosed keypad peripheral device comprises the following buttons: home 126, end 128, page up 130 and page down 132 keys. These buttons which are additional to a traditional numeric keypad promote greater work efficiency by allowing the operating hand to remain on the keypad peripheral device and not travel to a separate keyboard for access. This helps in maintenance of the user's eyes on the computer screen.

In a further embodiment, at least one key of the keypad has height which is less than the height of at least another key of the keypad. This embodiment may include keys that are standard height and at least one key with laptop key height. For example, standard “full-travel” alphanumeric keyboards may have keys that are typically on three-quarter inch centers (0.750 inches, 19.05 mm), and have a key travel of at least 0.150 inches (3.81 mm). Keys on laptops and notebook computers usually have a shorter travel distance for a keystroke. Keys having a height less than the height of other keys on the keypad of the keypad peripheral device may, for example, have a height that is similar to that of standard laptop or notebook computer keys. Including keys with reduced height helps avoid inadvertent contact with mistyping by a finger or base of an operating hand. In an embodiment, the reduced height keys are one or more of the following: the Home 126, Page Down 132, F8 110, Alt 134, and Ctrl 136 keys.

Alternatively, the keys of the keypad are programmable by an operator of the presently disclosed keypad peripheral device. The programmable keys can be configured to perform a variety of custom commands. For example, a very basic programmable key function might be for to access favorite programs with one click. For example, a user may link the first button to an email program, another to a web browser, and another to a word processing program, allowing for quick access to these frequently-used programs. Alternatively, the programmable key function of the instant keypad peripheral device may be used to magnify or reduce the size of an image on the screen, or to put the computer into a state of suspension or hibernation, for example.

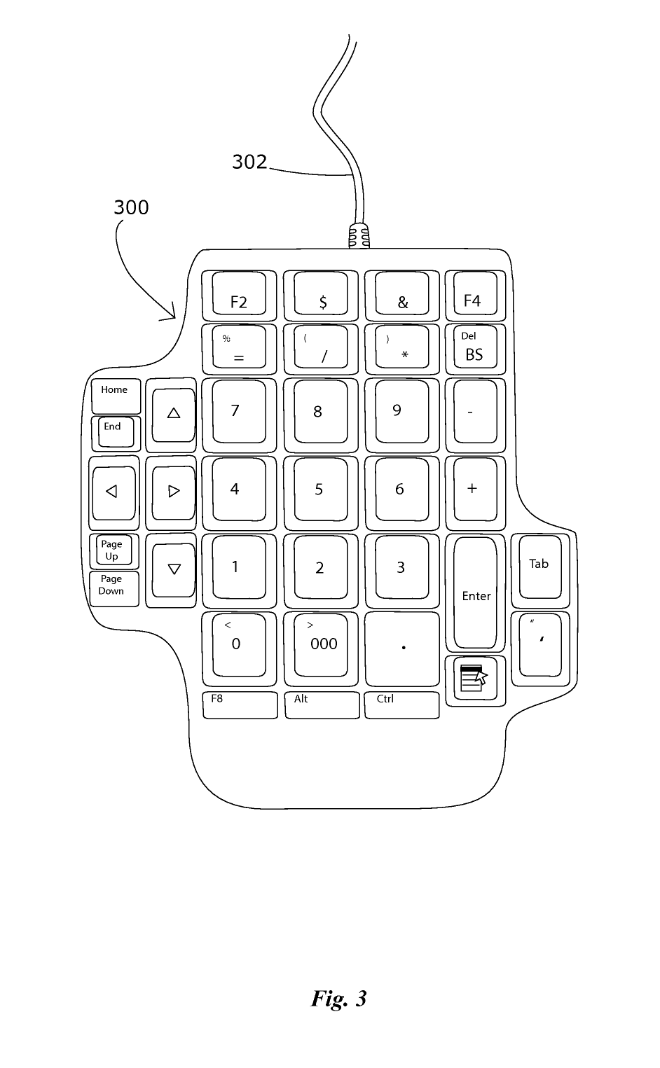

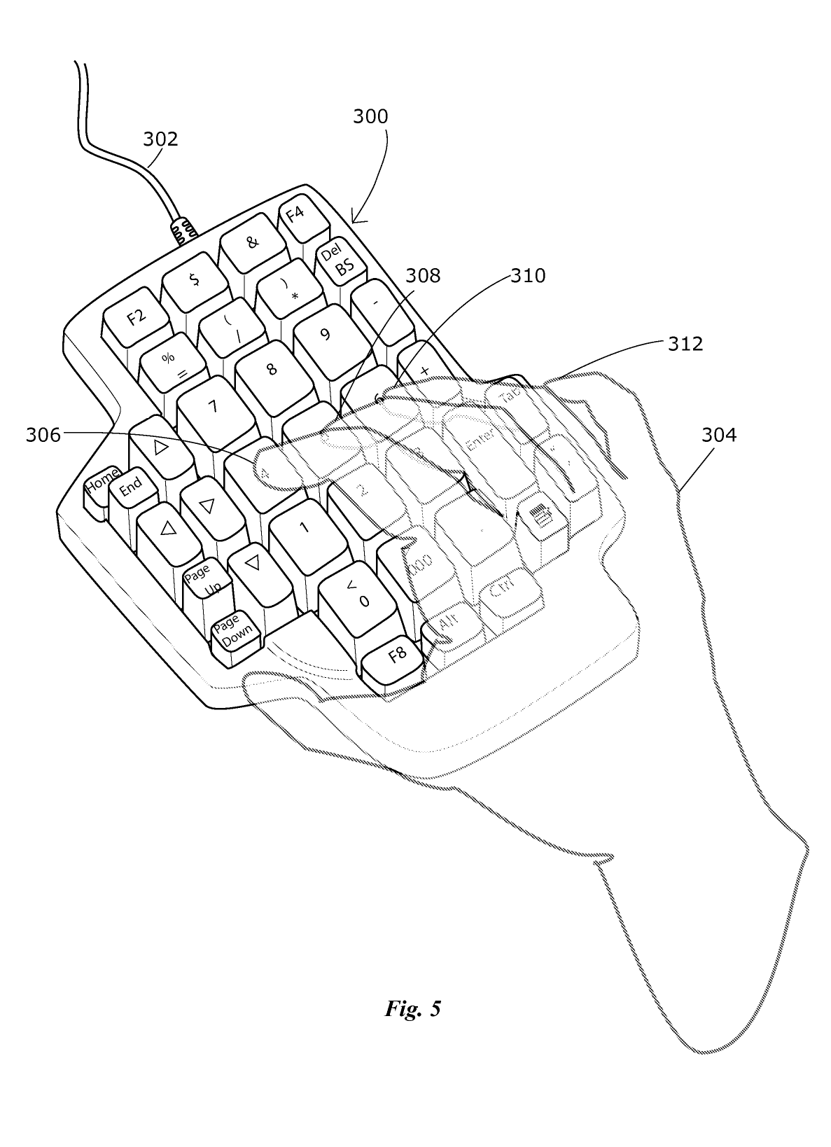

The present keypad peripheral device may be connected to a computer by a wired connection via connection standards such as USB, PS/2 or other connection standards appropriate for connection of a computer peripheral device to a computer. FIGS. 3 and 5 illustrate an embodiment of the present keypad peripheral device which is directed to a wired keypad peripheral device 300 including a wire 302. Alternatively, the present keypad peripheral device may be linked to a computer wirelessly, by communication via radio frequency or BLUETOOTH® for example.

It is also within the scope and content of the present disclosure to include an on/off switch 202 in another embodiment. The on/off switch may be used by a user to turn the power on or the turn the power off for the present keypad peripheral device.

The present description refers to the accompanying drawings that depict various details of examples selected to show how particular embodiments may be implemented. The discussion herein addresses various examples of the inventive subject matter at least partially in reference to these drawings and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

In this description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present disclosure includes a variety of combinations and/or integrations of the embodiments and examples described herein, as well as further embodiments and examples as defined within the scope of all claims based on this disclosure, as well as all legal equivalents of such claims. The terms “a,” “an,” “the” and similar referents used in the context of describing the invention (especially in the context of the following claims) are to be construed to cover both the singular and the plural, unless otherwise indicated herein or clearly contradicted by context.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. Furthermore, any cited references and printed publications are individually incorporated herein by reference in their entirety.

What is claimed is:

1. A keypad peripheral device comprising:
a housing which forms a top surface on which is located
a keypad comprising a numeric keypad, at least one function key, Tab key and right click key.

2. The keypad peripheral device of claim 1, wherein said at least one function key is F2 or F4 function key.

3. The keypad peripheral device of claim 1, wherein said at least one function key is F2 and F4 function keys.

4. The keypad peripheral device of claim 1, wherein said at least one function key is F2, F4 and F8 function keys.

5. The keypad peripheral device of claim 2, wherein said F2 or F4 function keys is located on a top row of said keypad.

6. The keypad peripheral device of claim 1, wherein said Tab key is operable by the pinkie finger of an operating hand.

7. The keypad peripheral device of claim 1, wherein said Tab key is located adjacent to the Enter key of said numeric keypad.

8. The keypad peripheral device of claim 1, wherein said right click is located directly below the Enter key of said numeric keypad.

9. The keypad peripheral device of claim 1, wherein said keypad further comprises directional keys.

10. The keypad peripheral device of claim 9, wherein said directional keys are in the shape of a sideways T.

11. The keypad peripheral device of claim 9, wherein said directional keys are operable by the index finger of an operating hand.

12. The keypad peripheral device of claim 1, wherein said keypad further comprises home, end, page up, and page down keys.

13. The keypad peripheral device of claim 1, wherein said keypad further comprises a back space (BS) or a Delete (Del) key.

14. The keypad peripheral device of claim 1, wherein at least one key of said keypad has a height less than at least another key of said keypad.

15. The keypad peripheral device of claim 1, wherein said at least one key with lesser height is positioned on said keypad to avoid inadvertent contact with a finger or base of an operating hand.

16. The keypad peripheral device of claim 1, wherein said keys of said keypad are programmable by an operator.

17. The keypad peripheral device of claim 1, wherein said keypad further comprises Alt and Control keys.

18. The keypad peripheral device of claim 1, further comprising an on/off switch on a bottom surface of said housing.

19. A keypad peripheral device comprising:
a housing which forms a top surface on which is located
a keypad comprising a numeric keypad, F2 and F4 function keys, Tab key and right click key, wherein said Tab key is located adjacent to the Enter key of said numeric keypad and said right click is located directly below said Enter key.
